(19) United States
(12) Patent Application Publication
(10) Pub. No.: US 2016/0028131 A1
(43) Pub. Date: Jan. 28, 2016

(54) BATTERY MODULE

(71) Applicant: SAMSUNG SDI CO., LTD., Yongin-si (KR)

(72) Inventor: Jangwook LEE, Yongin-si (KR)

(21) Appl. No.: 14/734,124

(22) Filed: Jun. 9, 2015

(30) Foreign Application Priority Data
Jul. 28, 2014 (KR) 10-2014-0096009

(51) Int. Cl. H01M 10/6557

(52) U.S. Cl. CPC H01M 10/6557; H01M 10/625; H01M 2220/20

(57) ABSTRACT

A battery module includes unit batteries each including long side surfaces and short side surfaces, with long side surfaces of adjacent unit batteries facing each other, a first spacer between the first unit battery and the second unit battery. A spacer includes a first side wall corresponding to a first short side surface of the first unit battery, the first side wall including a first hole through which fluid for cooling a bottom surface of the first unit battery is injectable, a bottom portion facing a bottom surface of the first unit battery, a support protrusion that spaces the bottom surface of the first unit battery apart from the bottom portion of the first spacer to provide a movement path of the fluid, and a second side wall at an opposite side of the first side wall, the second wall including a second hole through which the fluid is ejected.

### CROSS-REFERENCE TO RELATED APPLICATION

Korean Patent Application No. 10-2014-0096009, filed on Jul. 28, 2014, in the Korean Intellectual Property Office, and entitled: “Battery Module,” is incorporated by reference herein in its entirety.

### BACKGROUND

1. Field

One or more embodiments relate to a battery module.

2. Description of the Related Art

Unlike primary batteries, secondary batteries are generally rechargeable.

Secondary batteries may be used in the form of single batteries when used as power supply of small sized electronic devices such as cellular phones and portable computers. Secondary batteries may also be used in transportation equipment such as hybrid vehicles. In this case, secondary batteries may be used in the form of a battery module formed by connecting a plurality of batteries in a unit in accordance with demand for high output and high capacity batteries.

### SUMMARY

Embodiments are directed to a battery module including a first unit battery and a second unit battery. each including long side surfaces and first and second short side surfaces between the long side surfaces, the first unit battery and the second unit battery being disposed in one direction such that one long side surface of the first unit battery and one long side surface of the second unit battery face each other. and a first spacer between the first unit battery and the second unit battery. The first spacer further includes a first side wall at a location corresponding to the first short side surface of the first unit battery, the first side wall including a first hole through which fluid for cooling a bottom surface of the first unit battery is injectable, a bottom portion facing a bottom surface of the first unit battery, a support protrusion that spaces the bottom surface of the first unit battery apart from the bottom portion of the first spacer to provide a movement path of the fluid, and a second side wall at an opposite side of the first side wall, the second wall including a second hole through which the fluid is ejected.

The first hole and the second hole of the first spacer may extend downwardly such that ends of the first hole and the second hole extend beyond the bottom surface of the first unit battery.

The movement path of the fluid may be exposed to an outside of the battery module through the first hole and the second hole.

The first spacer may include a main body between the first side wall and the second side wall, and a plurality of protrusions protruding from the main body toward the long side surfaces of the first unit battery and the second unit battery. The long side surfaces may be substantially perpendicular to the first short side surface of the first unit battery.

The first spacer may include a third hole and a fourth hole such that the fluid is injectable into and ejectable from a space between the first spacer and the one long side surface of the first unit battery. The space between the first spacer and the one long side surface of the first unit battery may be formed by the plurality of protrusions.

The battery module may further include a second spacer that faces the first spacer such that the first unit battery between the first and second spacers. The first spacer may include a first concave part that is concave in a direction away from the second spacer such that a opening is formed when the first and second spacers are coupled to each other.

The first concave part may be located in an upper region of at least one of the first and second side walls of the first spacer.

The upper region of the first side wall may contact the first short side surface of the first unit battery.

The first unit battery may include first and second electrode terminals having opposite polarities, the first and second electrode terminals being located at a top portion of the first unit battery.

The second spacer may include a second concave part at a top portion of the second spacer. The second concave part may be concave in a direction away from the first spacer.

One of the first and second spacers may include a coupling protrusion and the other one of the first and second spacers may include a coupling groove that connects to the coupling protrusion.

The first hole and the second hole may be formed in a lower region of the first and second side portions of the first spacer, respectively. A gap may be between the lower region of the first side wall of the first spacer and the first short side surface of the first unit battery and between the lower region of the second side wall of the first spacer and the second short side surface of the first unit battery.

The support protrusion may be located adjacent to a side of the bottom portion of the first spacer.

### BRIEF DESCRIPTION OF THE DRAWINGS

Features will become apparent to those of skill in the art by describing in detail exemplary embodiments with reference to the attached drawings in which:

FIG. 1 illustrates a perspective view of a battery module according to an embodiment;

FIG. 2 illustrates a perspective view of a spacer of FIG. 1;

FIG. 3 illustrates an exploded perspective view of a part of the battery module of FIG. 1;

FIG. 4 illustrates a perspective view of a unit battery and first and second spacers of FIG. 1 that are coupled to each other;

FIG. 5 illustrates a plan view of a unit battery and a first spacer of FIG. 1 that are coupled to each other; and

FIG. 6 illustrates a schematic perspective view of a unit battery.

### DETAILED DESCRIPTION

Example embodiments will now be described more fully hereinafter with reference to the accompanying drawings; however, they may be embodied in different forms and should not be construed as limited to the embodiments set forth herein.

Rather, these embodiments are provided so that this disclosure will be thorough and complete, and will fully convey exemplary implementations to those skilled in the art.

In the drawing figures, the dimensions may be exaggerated for clarity of illustration. Like reference numerals refer to like elements throughout.

In the following descriptions of the embodiments, although the terms “first and second” are used to describe various elements, these elements should not be limited by these terms. These terms are only used to distinguish one element from another element. Unless provided otherwise, the terms of a singular form may include plural forms unless referred to the contrary.

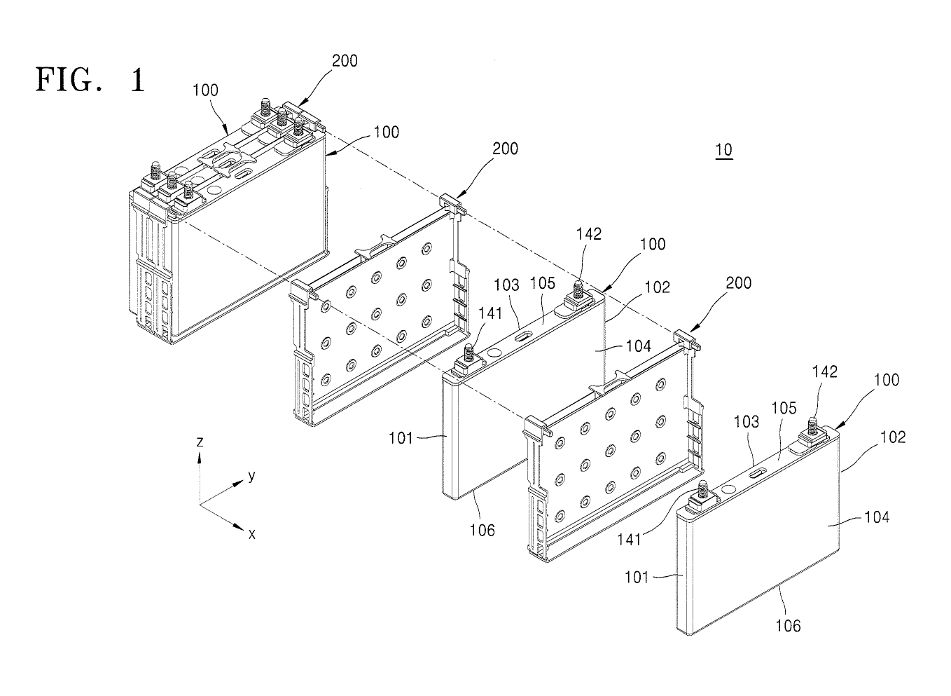

FIG. 1 illustrates a perspective view of a battery module according to an embodiment.

Referring to FIG. 1, the battery module 10 according to an embodiment may include a plurality of unit batteries 100 and a plurality of spacers 200 disposed between the unit batteries 100. The battery module may further include a housing that accommodates the unit batteries 100 and the spacers 200.

The unit batteries 100 may be secondary batteries such as lithium ion batteries.

The unit batteries 100 may be provided, for example, in an approximately prismatic shape. The unit batteries 100 may include first electrode terminals 141 and second electrode terminals 142 that have opposite polarities. The first electrode terminals 141 and the second electrode terminals 142 may be provided on top surfaces 105 of the unit batteries 100, and may extend away from the top surfaces 105 of the unit batteries 100. The first electrode terminals 141 and the second electrode terminals 142 may form electrical connections for sending electrical power stored in the unit batteries 100 to the outside or for receiving electrical power from the outside.

An electrode assembly (not shown) including a positive electrode plate, a negative electrode plate, and a separator disposed therebetween may be included in the unit batteries 100 as a power generation element. The electrode assembly may be formed by winding the positive electrode plate, the negative electrode plate, and the separator in the form of a roll. In another embodiment, the electrode assembly may be formed by sequentially stacking the positive electrode plate, the separator, and the negative electrode plate. One of the first electrode terminal 141 and the second electrode terminal 142 may be electrically connected to the positive electrode plate, and the other one may be electrically connected to the negative electrode plate. The unit batteries 100 may be charged and discharged through the first and second electrode terminals 141 and 142.

The unit batteries 100 may be arranged in one direction. For example, as shown in FIG. 1, third and fourth side surfaces 103 and 104, which are long side surfaces of the adjacent unit batteries 100, may be arranged to face each other. The unit batteries 100 arranged in one line may be electrically connected via a connection member such as a bus bar (not shown). For example, the unit batteries 100 may be connected to each other in series, parallel, or series-parallel.

The spacers 200 may be disposed between the unit batteries 100 arranged in one direction. The spacers 200 may be disposed between the adjacent unit batteries 100 and may provide a movement path through which a cooling fluid may come and go while accommodating the unit batteries 100.

Each of the unit batteries 100 may have the same shape. Each of the spacers 200 may have the same shape. Thus, a capacity of the battery module 10 may be modified in various ways by alternately placing the spacers 200 and the unit batteries 100.

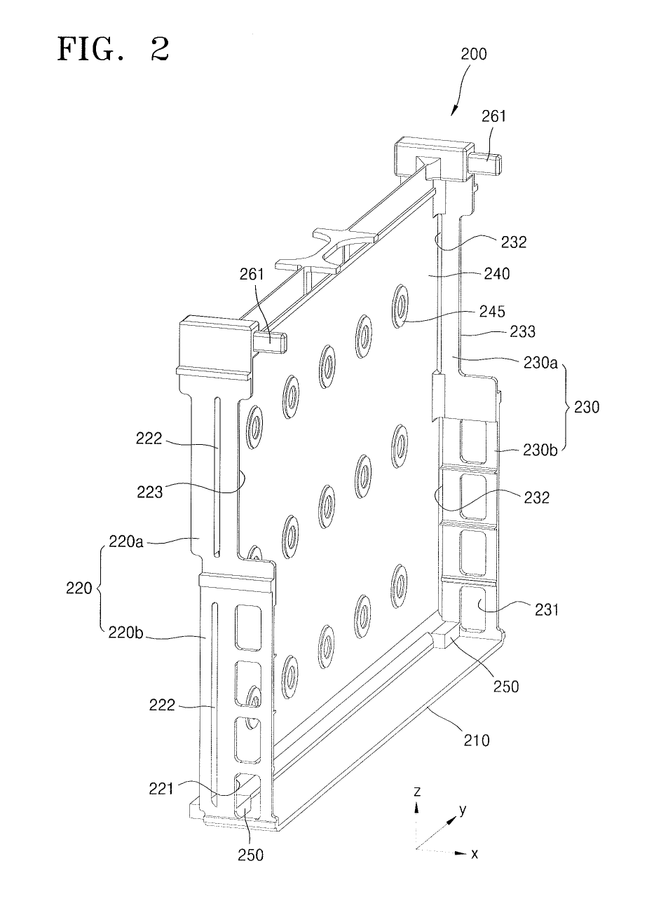

FIG. 2 illustrates a perspective view of the spacer 200 of FIG. 1.

Referring to FIG. 2, the spacer 200 according to an embodiment may include a bottom portion 210, a first side wall 220, and a second side wall 230 that are substantially perpendicular to the bottom portion 210, a main body 240 that is substantially perpendicular to the first and second side walls 220 and 230, and a support protrusion 250.

The support protrusion 250 may be formed on the bottom portion 210. The support protrusion 250 may extend having a predetermined height upward. When unit batteries 100 are accommodated in the spacer 200 such that bottom surfaces of the unit batteries 100 face the bottom portion 210, the support protrusion 250 may support the bottom surfaces of the unit batteries 100. The bottom surfaces of the unit batteries 100 may be spaced apart by a predetermined gap from the bottom portion 210 by the support protrusion 250.

The first side wall 220 may include a first hole 221 and a third hole 222. The second side wall 230 may include a second hole 231 and a fourth hole 232.

The first and second holes 221 and 231 may be respectively formed in a lower region 220b of the first side wall 220 and a lower region 230b of the second side wall 230. For example, the first and second holes 221 and 231 may extend downwardly in the lower region 220b or 230b of the spacer 200. One of the first and second holes 221 and 231 may be an inlet of fluid (for example, air) for cooling the bottom surfaces of the unit batteries 100, and another one thereof may be an outlet.

The third hole 222 may be formed in one side of the first side wall 220 adjacent to the main body 240. The fourth hole 232 may be formed in one side of the second side wall 230 adjacent to the main body 240. The third and fourth holes 222 and 232 may extend in a height direction of the main body 240. One of the third and fourth holes 222 and 232 may be an inlet of fluid (for example, air) for cooling side walls of the unit batteries 100, and another one thereof may be an outlet.

The main body 240 may include a protrusion portion 245. The protrusion portion 245 may be formed on one side of the main body 240. Long side surfaces of the unit batteries 100 facing the main body 240 may be spaced by a predetermined gap from the main body by the protrusion portion 245.

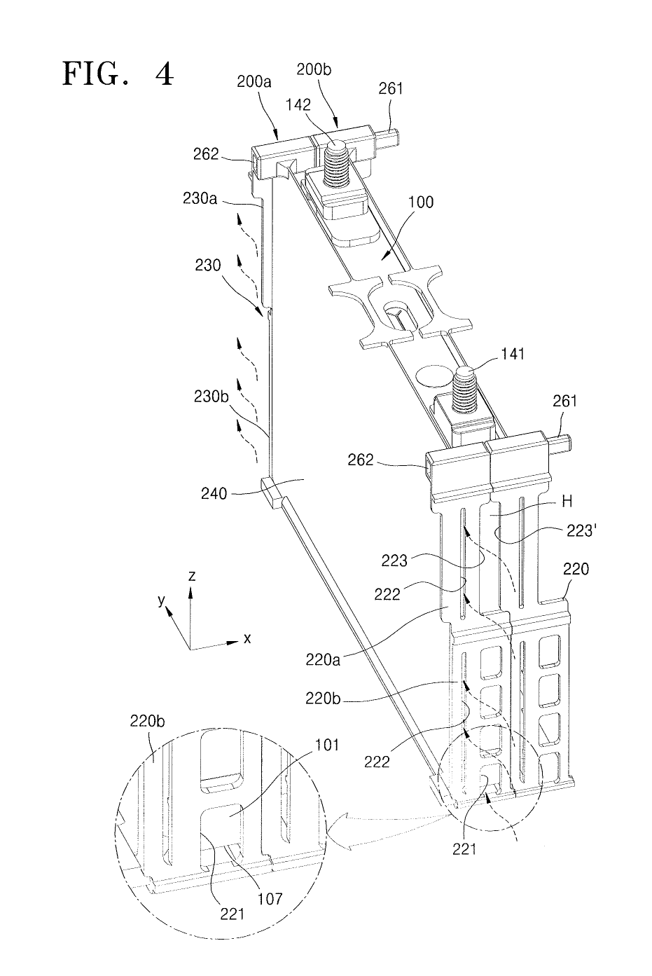

A coupling protrusion 261 may be provided on each of the first and second side walls 220 and 230. The coupling protrusion 261 may extend in one direction, for example, in the arrangement direction of the batteries 100. A coupling groove (262, see FIG. 4) into which the coupling protrusion 261 is insertable may be formed in an opposite side of the coupling protrusions 251. As shown in FIG. 4, when adjacent spacers 200a and 200b are coupled to each other with the unit batteries 100 disposed between the spacers 200a and 200b, the coupling protrusion 261 of the spacer 200a of one of the adjacent spacers 200a and 200b may be inserted into the coupling groove 262 of the spacer 200b of another one thereof.

The first side wall 220 may include a first concave part 223. The second side walls 230 may include a second concave part 233. Each of the first and second concave parts 223 and 233 may be formed in a region adjacent to a cap plate of the unit batteries 100, for example, upper regions 220a and 230a of the first and second side walls 220 and 230.

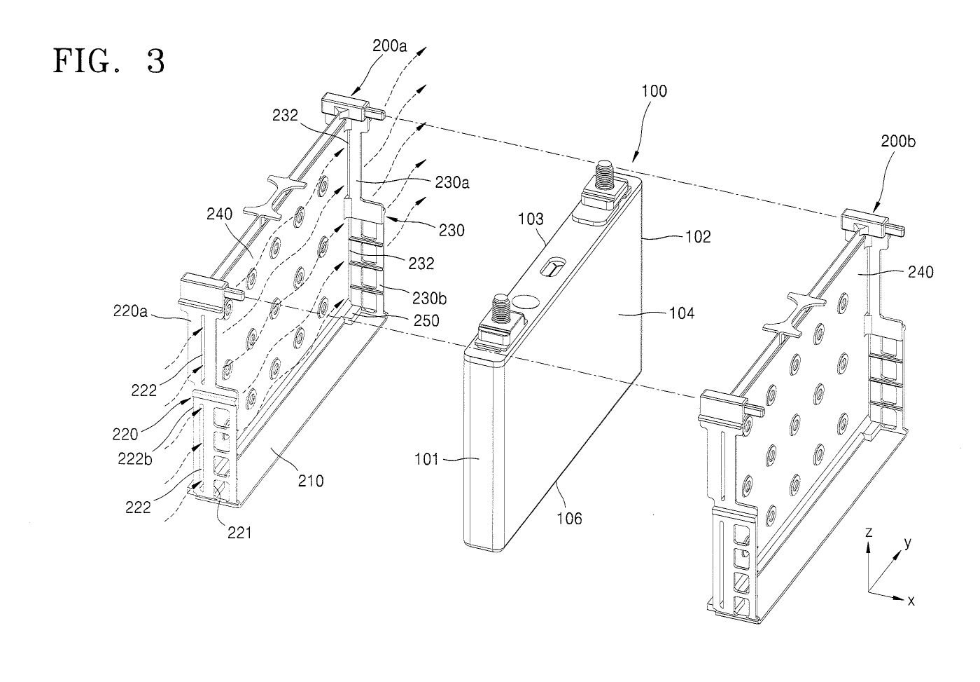

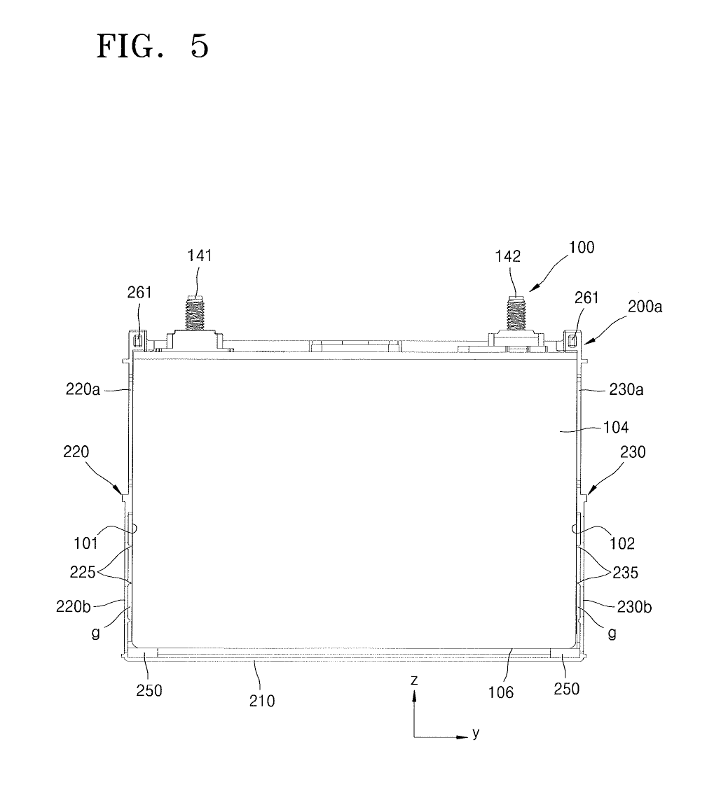

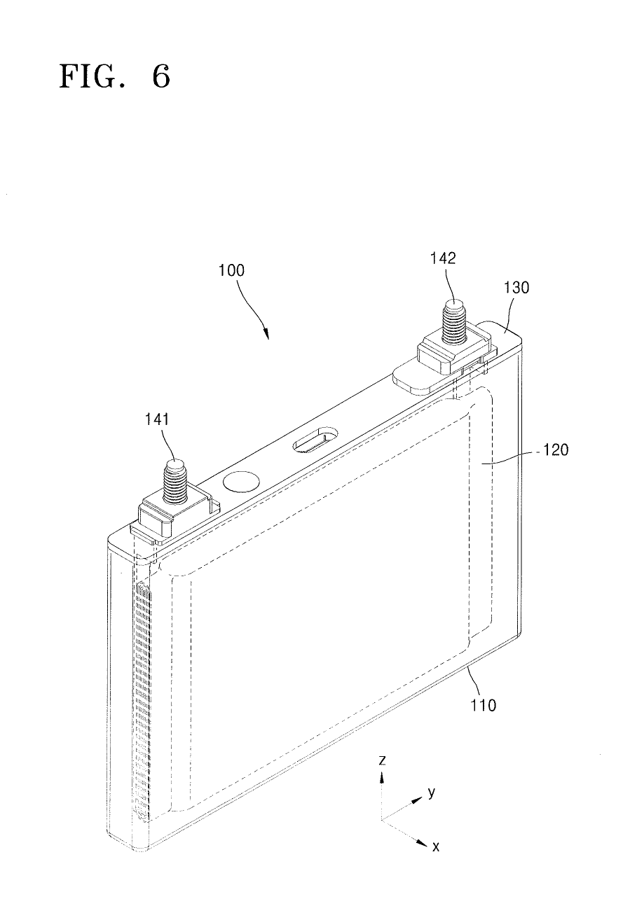

FIG. 3 illustrates an exploded perspective view of a part of the battery module of FIG. 1. FIG. 4 illustrates a perspective view of the unit battery 100 and first and second spacers 200a and 200b of FIG. 1 that are coupled to each other. FIG. 5 illustrates a plan view of the unit battery 100 and the first spacer 200a of FIG. 1 that are coupled to each other. FIG. 6 illustrates a schematic perspective view of the unit battery 100.

Referring to FIGS. 3 and 4, the first spacer 200a and the second spacer 200b may be provided at both sides of the unit battery 100. The unit battery 100 may be disposed between the first and second spacers 200a and 200b.

First and second short side surfaces 101 and 102 of the unit battery 100 may respectively face the first and second side walls 220 and 230 of the first spacer 200a. A third side surface 103 of the unit battery 100 may face the main body 240 of the first spacer 200a. A fourth side surface 104 of the unit battery 100 may face the main body 240 of the second spacer 200b.

A bottom surface 106 of the unit battery 100 may face the bottom portion 210 of the first spacer 200a. The bottom surface 106 of the unit battery 100 may be spaced apart by a predetermined distance from the bottom portion 210 of the first spacer 200a by the support protrusion 250. A space between the bottom surface 106 of the unit battery 100 and the bottom portion 210 of the first spacer 200a may be a movement path (hereinafter referred to as a bottom flow path) of fluid for cooling the bottom portion of the unit battery 100.

The bottom flow path may be fluidly connected to the outside. The first and second holes 221 and 231 respectively formed in the first and second side walls 220 and 230 of the first spacer 200a may extend downwardly in the first spacer 200a. As shown in FIG. 4, lower ends of the first and second holes 221 and 231 may extend beyond the bottom surface 106 of the unit battery 100. For example, the lower ends of the first and second holes 221 and 231 may extend downwardly in the first spacer 200a and may extend beyond a corner 107 (referring FIG. 4) formed by the first short side surface 101 and the bottom surface 106 of the unit battery 100. The bottom flow path may be exposed to the outside through the first and second holes 221 and 231.

One of the first and second holes 221 and 231 may be an inlet of a cooling fluid for cooling the bottom portion of the unit battery 100, and another one thereof may be an outlet.

The support protrusion 250 may be located adjacent to one side of the bottom portion 210 of the first spacer 200a as shown in FIG. 3 such that when the cooling fluid moves through the bottom flow path. the movement of the cooling fluid is be prevented by the support protrusion 250.

If the support protrusions 250 were to be formed at a center of the bottom portion 210 of the first spacer 200a, the bottom surface 106 of the unit battery 100 of a location corresponding to the support protrusion 250 might not contact the cooling fluid. In this case, it may be difficult to uniformly cool the bottom surface 106 of the unit battery 100.

The third side surface 103 of the unit battery 100 may face the main body 240 of the first spacer 200a. The third side surface 103 of the unit battery 10 may be spaced apart by a predetermined gap from the main body 240 of the first spacer 200a by the protrusion portion 245. A space between the third side surface 103 of the unit battery 100 and the main body 240 of the first spacer 200a may be a movement path (hereinafter referred to as a side flow path) of fluid for cooling side surfaces of the unit battery 100.

The side flow path may be fluidly connected to the outside. For example, the third and fourth holes 222 and 232 formed in the first and second side walls 220 and 230 of the first spacer 200a may extend in a height direction of the main body 240 and may be an inlet and an outlet of the cooling fluid. One of the third and fourth holes 222 and 232 may be the inlet of the cooling fluid for cooling the side surfaces of the unit battery 100, and another one thereof may be the outlet.

Referring to FIG. 5, the lower region 220b of the first side wall 220 may be spaced apart from the first short side surface 101 of the unit battery 100 by a rib 225 to form a gap g between the first short side surface 101 and the lower region 220b of the first side wall 220. The lower region 230b of the second side wall 230 may be spaced apart from the second short side surface 102 of the unit battery 100 by a rib 235 to form the gap g between the second short side surface 102 and the lower region 230b of the second side wall 230.

The upper region 220a of the first side wall 220 may directly contact the first short side surface 101 of the unit battery 100. The upper region 230a of the second side wall 230 may directly contact the second short side surface 102 of the unit battery 100. The upper regions 220a and 230a of the first and second side walls 220 and 230 may directly contact the first and second short side surfaces 101 and 102 of the unit battery 100. A movement of the unit battery 100 accommodated in the first spacer 200a may be inhibited.

However, if water drops were to form in the first spacer 200a and the unit battery 100 due to a temperature difference between the cooling fluid for cooling the unit battery 100 and the unit battery 100, stability of the unit battery 100 could be greatly deteriorated.

As shown in FIG. 6, the unit battery 100 may include a case 110 having an opened top surface, an electrode assembly 120 accommodated in the case 110, a cap plate 130 sealing the top surface of the case 110, and first and second electrode terminals 141 and 142 exposed toward the outside of the cap plate 130.

The case 110 may be an all-in-one type having the opened top surface. Even if water drops were to be formed in a bottom portion of the case 110, it would be difficult for the water drops to penetrate into the unit battery 100. However, when the upper region 220a of the first side wall 220 and the upper region 230a of the second side wall 230 directly contact the unit battery 100, a small gap may be formed between the upper regions 220a and 230a of the first and second side walls 220 and 230 and the side surfaces 101 and 102 of the unit battery 100. It may be possible for water drops to move through the small gap due to a capillary phenomenon. The top surface of the case 110 may be assembled by welding with the cap plate 130 or by using a gasket. Accordingly, if the top surface were to be exposed to water drops (moisture), there is a risk unit battery 100 could be internally short circuited or could deteriorate.

According to the present embodiment, as shown in FIGS. 2 and 4, the first and second side walls 220 and 230 may include first and second concave parts 223 and 233 respectively through which water drops may drip to escape the battery module 10. To prevent or reduce the likelihood of water drops penetrating into the unit battery 100 through the cap plate 130 and the case 110, the first and second concave parts 223 and 233 may be respectively formed in the upper regions 220a and 220b of the first and second side walls 220 and 230, which are adjacent to the cap plate 130 and the top portions of the case 110.

The first and second concave parts 223 and 233 formed in the first spacer 200a may have concave shapes in a direction away from the second spacer 200b. The first and second concave parts 223 and 233 formed in the first and second side walls 220 and 230 of the first spacer 200a may be coupled to the first and second side walls 220 and 230 of the second spacer 200b to form an opening H. Water drops that may be formed near the opening H formed by the first and second concave parts 223 and 233 may drip to the outside of the battery module 10 through the opening H.

In other implementations, as shown in FIG. 4, a third concave part 223′ may be formed in the first side wall 220 of the second spacer 200b that is coupled to the first concave part 223 of the first spacer 200a, and a fourth concave part (not shown) may be formed in the second side wall 230 of the second spacer 200b that is coupled to the second concave part 233 of the first spacer 200a.

According to the above-described embodiments, the first and second spacers 200a and 200b disposed at both sides of the unit battery 100 may fix a location of the unit battery 100. According to the above-described embodiments, a bottom portion and/or side surfaces of the unit battery 100 may be cooled through the first and second spacers 200a and 200b provided at both sides of the unit battery 100. According to the one or more of the above embodiments, cooling efficiency of a battery module may be improved.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly. it will be understood by those of skill in the art that various changes in form and details may be made without departing from the spirit and scope thereof as set forth in the following claims.

What is claimed is:

1. A battery module, comprising:
a first unit battery and a second unit battery each including long side surfaces and first and second short side surfaces between the long side surfaces, the first unit battery and the second unit battery being disposed in one direction such that one long side surface of the first unit battery and one long side surface of the second unit battery face each other; and
a first spacer between the first unit battery and the second unit battery,
wherein the first spacer further includes:
a first side wall at a location corresponding to the first short side surface of the first unit battery, the first side wall including a first hole through which fluid for cooling a bottom surface of the first unit battery is injectable;
a bottom portion facing a bottom surface of the first unit battery;
a support protrusion that spaces the bottom surface of the first unit battery apart from the bottom portion of the first spacer to provide a movement path of the fluid; and
a second side wall at an opposite side of the first side wall, the second wall including a second hole through which the fluid is ejected.

2. The battery module as claimed in claim 1, wherein the first hole and the second hole of the first spacer extends downwardly such that ends of the first hole and the second hole extend beyond the bottom surface of the first unit battery.

3. The battery module as claimed in claim 1, wherein the movement path of the fluid is exposed to an outside of the battery module through the first hole and the second hole.

4. The battery module as claimed in claim 1, wherein:
the first spacer includes a main body between the first side wall and the second side wall and a plurality of protrusions protruding from the main body toward the long side surfaces of the first unit battery and the second unit battery, and
the long side surfaces are substantially perpendicular to the first short side surface of the first unit battery.

5. The battery module as claimed in claim 4, wherein:
the first spacer includes a third hole and a fourth hole such that the fluid is injectable into and ejectable from a space between the first spacer and the one long side surface of the first unit battery, and
the space between the first spacer and the one long side surface of the first unit battery is formed by the plurality of protrusions.

6. The battery module as claimed in claim 1, further comprising a second spacer that faces the first spacer such that the first unit battery between the first and second spacers,
wherein the first spacer includes a first concave part that is concave in a direction away from the second spacer such that an opening is formed when the first and second spacers are coupled to each other.

7. The battery module as claimed in claim 6, wherein the first concave part is located in an upper region of at least one of the first and second side walls of the first spacer.

8. The battery module as claimed in claim 7, wherein the upper region of the first side wall contacts the first short side surface of the first unit battery.

9. The battery module as claimed in claim 7, wherein the first unit battery includes first and second electrode terminals having opposite polarities, the first and second electrode terminals being located at a top portion of the first unit battery.

10. The battery module as claimed in claim 7, wherein:
the second spacer includes a second concave part at an upper region of at least one of the first and second side walls of the second spacer corresponding to the first concave part located at the upper region of at least one of the first and second side walls of the first spacer, and the second concave part is concave in a direction away from the first spacer.

11. The battery module as claimed in claim 6, wherein one of the first and second spacers includes a coupling protrusion and the other one of the first and second spacers includes a coupling groove that connects to the coupling protrusion.

12. The battery module as claimed in claim 1,
the first hole and the second hole are formed in a lower region of the first side wall and the second side wall of the first spacer, respectively, and
a gap is between the lower region of the first side wall of the first spacer and the first short side surface of the first unit battery and between the lower region of the second side wall of the first spacer and the second short side surface of the first unit battery.

13. The battery module as claimed in claim 1, wherein the support protrusion is located adjacent to a side of the bottom portion of the first spacer.
